(19) United States
(12) Patent Application Publication
(10) Pub. No.: US 2022/0185457 A1
(43) Pub. Date: Jun. 16, 2022

(54) FLUID ADJUSTMENT DEVICE AND AIRCRAFT

(71) Applicant: MITSUBISHI HEAVY INDUSTRIES, LTD., Tokyo (JP)

(72) Inventors: Yuki MORISAKI, Tokyo (JP); Yasuhiro SAIKI, Tokyo (JP); Kazuhiro IMAI, Tokyo (JP)

(21) Appl. No.: 17/418,025

(22) PCT Filed: Dec. 26, 2019
(86) PCT No.: PCT/JP2019/051225

§ 371 Date: Jun. 24, 2021

(30) Foreign Application Priority Data
Jan. 31, 2019 (JP) 2019-015719

(51) Int. Cl. B64C 21/02; B64C 23/06

(52) U.S. Cl. CPC B64C 21/025; B64C 23/065

(57) ABSTRACT

A fluid adjustment device is provided with: a body part mounted on a wing tip, which is an end part of a main wing on the opposite side to the wing root, and having an upper opening and a lower opening formed in an upper surface of the body part and a lower surface of the body part; a first Francis turbine that sucks air from the upper opening and the lower opening and discharges the sucked air from the trailing edge side of the main wing; and a first motor for rotating the first Francis turbine in a direction opposite to a rotation direction of a wingtip vortex generated at the wingtip. The first Francis turbine has a central axis extending from the leading edge of the main wing toward the trailing edge, sucks air from the circumferential direction, and discharges the sucked air in the axial direction.

### TECHNICAL FIELD

The present invention relates to a fluid adjustment device and an aircraft.

### BACKGROUND ART

When the aircraft navigates, there is a pressure difference between an upper surface and a lower surface of a main wing of the aircraft. Due to the pressure difference, an air stream flows from the lower surface (pressure surface) to the upper surface (suction surface) in the vicinity of a wing tip (end portion on side opposite to wing root) of the main wing, so that wingtip vortices are generated (refer to FIG. 10). The wingtip vortices act in a direction such that the angle of attack of a wing is decreased and increase induced drag, which is a cause of a decrease in fuel efficiency of the aircraft.

Therefore, a technique of suppressing wingtip vortices, which cause induced drag, in order to suppress induced drag is known (for example, PTL 1 and PTL 2).

### CITATION LIST

### Patent Literature

[PTL 1] U.S. Pat. No. 4,917,332
[PTL 2] Japanese Unexamined Patent Application Publication No. 2004-168170

### SUMMARY OF INVENTION

### Technical Problem

As a technique of suppressing wingtip vortices, for example, there are a technique in which a winglet is provided at a wing tip of a main wing and a technique in which a propeller is rotated in a direction opposite to a rotation direction of wingtip vortices in the case of a propeller aircraft. However, winglets are heavy and may cause a problem that the weight of an aircraft is increased. In addition, a configuration in which wingtip vortices are suppressed by means of a propeller has a problem that such a configuration cannot be used for an aircraft other than a propeller aircraft. For these reasons, a device capable of suppressing generation of wingtip vortices by different means is desired.

The present invention has been made in view of such circumstances and an object thereof is to provide a fluid adjustment device and an aircraft with which it is possible to suppress generation of wingtip vortices and reduce induced drag.

### Solution to Problem

A fluid adjustment device and an aircraft according to an aspect of the present invention adopt the following means in order to solve the above-described problems.

A fluid adjustment device according to the aspect of the present invention includes a body part that is provided at a wing tip, which is an end portion opposite to a wing root of a wing, and includes a suction opening formed in one or both of a pressure surface and a suction surface, a first fan that sucks air from the suction opening and discharges the sucked air from a trailing edge side of the wing, and a first drive unit that rotates the first fan in a direction opposite to a rotation direction of wingtip vortices generated at the wing tip.

At the wing tip of the wing, vortex-shaped air steams called wingtip vortices are generated since air streams flows round from the pressure surface to the suction surface via (going around) the vicinity of the wing tip. Since the wingtip vortices act in a direction such that the angle of attack of the wing is decreased, the wingtip vortices result in drag (hereinafter, will be referred to as “induced drag”) with respect to the wing.

In the case of the above-described configuration, the suction opening is formed in one or both of the pressure surface and the suction surface. Accordingly, the first fan sucks a portion of an air stream flowing from the pressure surface to the suction surface. That is, the portion of the air stream which causes generation of the wingtip vortices is sucked by the first fan and is discharged to the trailing edge side. Therefore, generation of the wingtip vortices can be suppressed.

In addition, in the case of the above-described configuration, the first fan rotates in the direction opposite to the rotation direction of the wingtip vortices. Accordingly, the air discharged from the first fan becomes a vortex that swirls in a direction opposite to the wingtip vortices. In addition, in the above-described configuration, the first fan discharges air sucked from the suction opening, from the trailing edge side. Accordingly, air swirling in a direction opposite to the wingtip vortices is discharged from the trailing edge side of the wing. Therefore, at the trailing edge side of the wing, the air discharged from the first fan suppresses generation of the wingtip vortices. Accordingly, induced drag can be reduced.

In addition, in the case of the above-described configuration, the first fan discharges air sucked from one or both of the pressure surface and the suction surface, from the trailing edge side of the wing. Accordingly, with the first fan, the air sucked from one or both of the pressure surface and the suction surface can be used as thrust (force with which wing moves in direction toward leading edge).

In addition, in the fluid adjustment device according to the aspect of the present invention, the first fan may be a Francis turbine of which a central axis extends in a direction from a leading edge to a trailing edge of the wing, that sucks air from a circumferential direction, and that discharges the sucked air in an axial direction.

In the case of the above-described configuration, the Francis turbine of which the central axis extends in the direction from the leading edge to the trailing edge of the wing, that sucks air from the circumferential direction, and that discharges the sucked air in the axial direction is used as the first fan. That is, the air discharged from the Francis turbine is discharged from the trailing edge side of the wing. Accordingly, it is possible to discharge air from the trailing edge side of the wing without providing a structure (for example, duct) for guiding the air discharged from the Francis turbine to the trailing edge side. Therefore, a configuration can be simplified.

In addition, in the fluid adjustment device according to the aspect of the present invention, the first fan may include a cross flow fan of which a central axis extends in a direction from a leading edge to a trailing edge of the wing, that sucks air from a circumferential direction, and that discharges the air in the circumferential direction, and a duct that guides the air discharged from the cross flow fan to the trailing edge side of the wing.

In the case of the above-described configuration, the first fan includes the cross flow fan that sucks air from the circumferential direction and discharges air in the circumferential direction and the duct that guides the air discharged from the cross flow fan to the trailing edge side of the wing. Accordingly, the air discharged from the cross flow fan can be discharged from the trailing edge side of the wing via the duct. In addition, since the configuration of the cross flow fan is relatively simple, the cross flow fan is small in comparison with a device having other functions (for example, a device that discharges air sucked from circumferential direction in axial direction), as a device sucking air from one or both of the pressure surface and the suction surface. Therefore, reduction in size can be achieved in comparison with a configuration in which the device having other functions is used as the device sucking air from one or both of the pressure surface and the suction surface.

In addition, the fluid adjustment device according to the aspect of the present invention may further include a second fan that extends in a wing spanwise direction of the wing, is provided along a trailing edge of the wing, sucks air along one or both of the pressure surface and the suction surface of the wing, and discharges the sucked air to a turbine and a second drive unit that rotationally drives the second fan and the first drive unit may be the turbine that is provided at an end portion of the first fan in an axial direction and is rotationally driven by means of the air discharged from the second fan.

In the case of the above-described configuration, the second fan that is provided along the trailing edge of the wing, sucks air along one or both of the pressure surface and the suction surface of the wing, and discharges the sucked air to the turbine is provided. Accordingly, separation of air can be suppressed with the second fan sucking air separated from the pressure surface or the suction surface of the wing. Therefore, drag with respect to the wing can be suppressed.

In addition, the air discharged from the second fan is supplied to the turbine and the first fan is driven by the turbine. Accordingly, the turbine does not need a wire or the like and thus a configuration can be simplified and reduction in weight can be achieved in comparison with a configuration in which an electric motor or the like which needs a wire or the like is provided as a drive device for driving the first fan.

An aircraft according to an aspect of the present invention includes any of the fluid adjustment devices above-described.

In the case of the above-described configuration, generation of wingtip vortices at the wing tip of the wing of the aircraft can be suppressed. Therefore, induced drag can be reduced. Therefore, the fuel efficiency of the aircraft can be improved.

### Advantageous Effects of Invention

According to the aspects of the present invention, it is possible to prevent generation of wingtip vortices and reduce induced drag.

### BRIEF DESCRIPTION OF DRAWINGS

FIG. 1 is a schematic plan view of an aircraft according to a first embodiment of the present invention.

FIG. 2 is a cross-sectional view taken along line II-II of FIG. 1 as seen along arrows.

FIG. 3 is a cross-sectional view taken along line III-III of FIG. 1 as seen along arrows.

FIG. 4 is a cross-sectional view showing a modification example (Modification Example 1) of FIG. 2.

FIG. 5 is a cross-sectional view showing a modification example (Modification Example 1) of FIG. 3.

FIG. 6 is a schematic plan view of an aircraft according to a second embodiment of the present invention.

FIG. 7 is a cross-sectional view taken along line VII-VII of FIG. 6 as seen along arrows.

FIG. 8 is a cross-sectional view taken along line VIII-VIII of FIG. 6 as seen along arrows.

FIG. 9 is a cross-sectional view showing a modification example (Modification Example 2) of FIG. 7.

FIG. 10 is a front view schematically showing wingtip vortices generated at a wing tip of an aircraft.

### DESCRIPTION OF EMBODIMENTS

Hereinafter, an embodiment of a fluid adjustment device and an aircraft according to the present invention will be described with reference to the drawings. Note that, “FR” in the drawings means the front side of the aircraft, “UP” in the drawings means the upper side of the aircraft, and “IN” in the drawings means the inner side of the aircraft in a width direction. In addition, in the following description, a front-rear direction means a front-rear direction of the aircraft and a right-left direction means a right-left direction in a state of facing the front side of the aircraft.

### First Embodiment

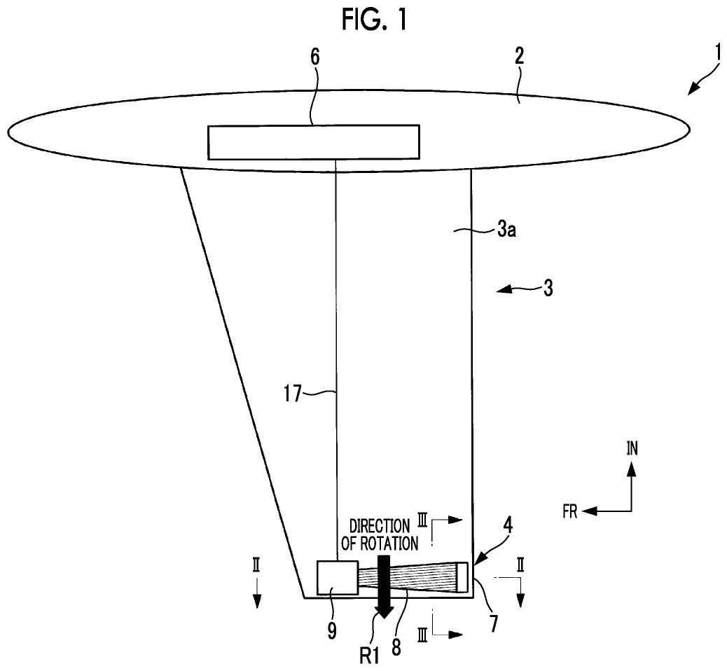

Hereinafter, a first embodiment of the present invention will be described with reference to FIGS. 1 to 3. In the present embodiment, an example in which a fluid adjustment device 4 is provided at a main wing of an aircraft 1 will be described.

As shown in FIG. 1, the aircraft 1 includes a fuselage 2, a main wing (wing) 3 of which a wing root, which is one end in a wing spanwise direction, is fixed to the fuselage 2, and the fluid adjustment device 4 provided at a wing tip which is the other end of the main wing 3. Note that, in FIG. 1, one (main wing 3 on right side of aircraft 1) of two main wings 3 is not shown for the sake of illustration. In addition, since the fluid adjustment device 4 is embedded in a body part 7, the fluid adjustment device 4 cannot be visually recognized when actually viewed in a plan view. However, for the sake of illustration, the fluid adjustment device 4 is represented with a solid line in FIG. 1.

The fuselage 2 includes an internal space for carrying passengers and/or cargo. In addition, a battery 6 is provided in the fuselage 2. Note that, a generator may be provided instead of the battery 6.

The main wing 3 includes an upper surface (suction surface) of the main wing 3 and a lower surface (pressure surface) of the main wing 3.

The fluid adjustment device 4 includes the body part 7 that is integrally formed with the main wing 3 and serves as a portion of the main wing 3, a first Francis turbine (first fan) 8 that is provided to be embedded in the body part 7, and a first motor (first drive unit) 9 that is provided in front of the first Francis turbine 8.

As shown in FIGS. 1 and 3, the body part 7 includes a body part upper surface (suction surface) 11 and a body part lower surface (pressure surface) 12. The body part upper surface 11 is integrally formed to be flush with a main wing upper surface 3a. In addition, an upper surface curved portion 11a that is downwardly curved is formed at a tip end of the body part upper surface 11 in the wing spanwise direction (refer to FIG. 3). The body part lower surface 12 is integrally formed to be flush with a main wing lower surface 3b. In addition, a lower surface curved portion 12a that is upwardly curved is formed at a tip end of the body part lower surface 12 in the wing spanwise direction. A lower end of the upper surface curved portion 11a and an upper end of the lower surface curved portion 12a are connected to each other (refer to FIG. 3).

As shown in FIG. 3, a first internal space S1 that extends in the front-rear direction and of which a section in a longitudinal direction is approximately circular is formed inside the body part 7. An upper opening (suction opening) 13, through which the first internal space S1 formed inside the body part 7 and the outside communicate with each other, is formed in the upper surface curved portion 11a of the body part 7. The length of the upper opening 13 in the front-rear direction is approximately the same as the length of the first internal space S1 in the front-rear direction. In addition, a lower opening (suction opening) 14, through which the first internal space S1 and the outside communicate with each other, is formed in the lower surface curved portion 12a of the body part 7. The length of the lower opening 14 in the front-rear direction is approximately the same as the length of the first internal space S1 in the front-rear direction. In addition, a discharge opening 15, through which the first internal space S1 and the outside of a trailing edge side of the body part 7 communicate with each other, is formed in the trailing edge side (rear end) of the body part 7.

The first Francis turbine 8 is a cylindrical member that is rotatably disposed in the first internal space S1 such that the central axis thereof extends along the longitudinal direction of the first internal space S1. In addition, the first Francis turbine 8 is formed such that the diameter thereof gradually increases toward a rear side from a front side. The first Francis turbine 8 includes a plurality of blade portions 16 that are disposed to be arranged in a circumferential direction around the central axis at predetermined intervals. Since each blade portion 16 is provided apart from the central axis, a space that extends in the longitudinal direction while being centered on the central axis is formed inside the first Francis turbine 8. Each blade portion 16 is formed such that air introduced from a circumferential direction is guided to the internal space and the introduced air flows toward the rear side through the space. That is, the first Francis turbine 8 rotates around the central axis so that air is sucked thereinto from the circumferential direction and the air sucked is discharged from a rear side in an axial direction.

The first motor 9 is provided in front of the first Francis turbine 8. The first motor 9 is electrically connected to the battery 6 provided in the fuselage 2 by means of a wire 17 and is driven by electric power from the battery 6. The first motor 9 is connected to a front end of the first Francis turbine 8 and when the first motor 9 is driven, the first Francis turbine 8 rotates around the central axis. Specifically, the first motor 9 rotates the first Francis turbine 8 in a direction opposite to a rotation direction of wingtip vortices generated at a wing tip. That is, as represented by an arrow R1 in FIG. 3, the first Francis turbine 8 is rotated such that the blade portions 16 move from an upper side (pressure surface side) to a lower side (suction surface side) at a half of the first Francis turbine 8 that is on a tip end side in the wing spanwise direction as seen in a front view of the first Francis turbine 8. In addition, as represented by the arrow R1 in FIG. 1, the first Francis turbine 8 is rotated such that the blade portions 16 move from a wing root side to a wing tip side at the upper half of the first Francis turbine 8 as seen in a plan view of the first Francis turbine 8.

In addition, the aircraft 1 in the present embodiment includes a control device (not shown) that controls the first motor 9.

The control device is composed of, for example, a central processing unit (CPU), a random access memory (RAM), a read only memory (ROM), a computer-readable storage medium, and the like. In addition, a series of processes for realization of various functions are stored in a storage medium or the like in the form of a program and the various functions are realized when the CPU reads the program into the RAM or the like and executes information processing and arithmetic processing, for example. Note that, a configuration in which the program is installed in the ROM or other storage mediums in advance, a configuration in which the program is provided in a state of being stored in the computer-readable storage medium, a configuration in which the program is distributed via communication means in a wired or wireless manner, or the like may also be applied. Examples of the computer-readable storage medium include a magnetic disk, a magneto-optical disk, a CD-ROM, a DVD-ROM, a semiconductor memory, and the like.

Next, the effect of the aircraft 1 according to the present embodiment will be described.

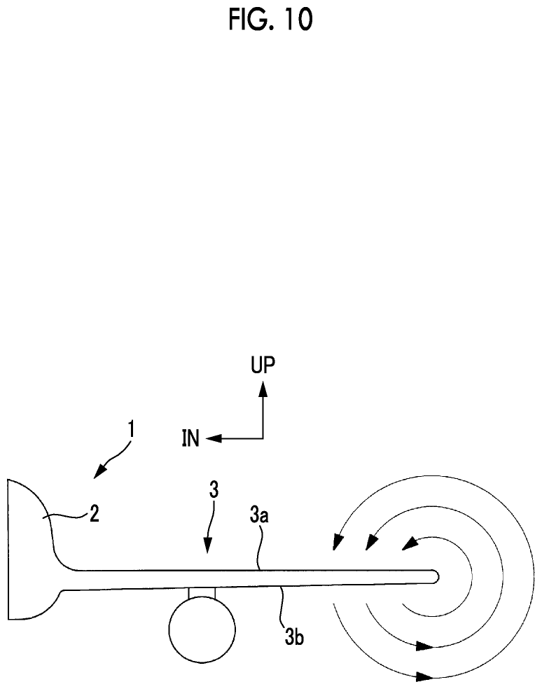

While the aircraft 1 is navigating, there is a pressure difference between the main wing upper surface 3a (suction surface) and the main wing lower surface 3b (pressure surface). Due to the pressure difference, an air stream flows from the main wing lower surface 3b to the main wing upper surface 3a in the vicinity of the wing tip of the main wing 3, so that wingtip vortices are generated (refer to FIG. 10). Since the wingtip vortices act in a direction such that the angle of attack of a wing is decreased, the wingtip vortices result in drag (hereinafter, will be referred to as “induced drag”) with respect to the wing.

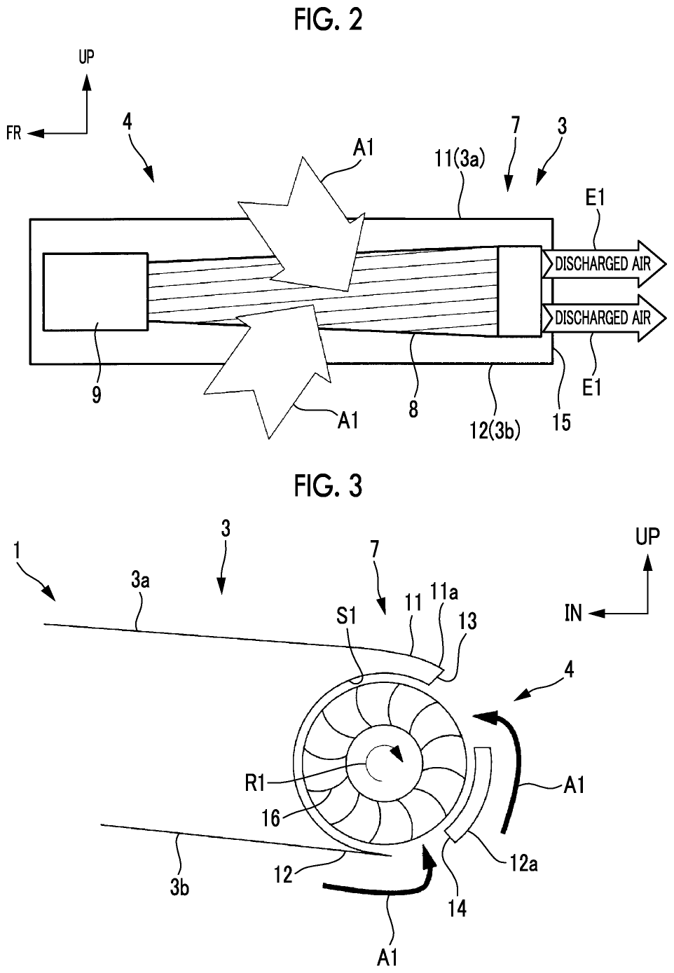

In the case of the aircraft 1 according to the present embodiment, the first motor 9 is driven during navigation so that the first Francis turbine 8 is rotationally driven. When the first Francis turbine 8 rotates, as represented by arrows A1 in FIGS. 2 and 3, the first Francis turbine 8 sucks a portion of an air stream flowing from the main wing lower surface 3b (pressure surface) to the main wing upper surface 3a (suction surface) via the upper opening 13 and the lower opening 14 formed in the body part 7. The first Francis turbine 8 discharges the sucked air from the rear side in the axial direction. As represented by arrows E1 in FIG. 2, the air discharged from the first Francis turbine 8 is discharged to a space (rear space) close to a trailing edge of the main wing 3 via the discharge opening 15 formed in the body part 7. Since the first Francis turbine 8 rotates in a direction opposite to a swirling direction of the wingtip vortices, the air discharged to the space close to the trailing edge of the main wing 3 becomes a vortex swirling in the direction opposite to the swirling direction of the wingtip vortices.

According to the present embodiment, the following effects can be achieved.

In the present embodiment, the first Francis turbine 8 sucks a portion of an air stream flowing from the main wing lower surface 3b (pressure surface) to the main wing upper surface 3a (suction surface) from the upper opening 13 formed in the upper surface curved portion 11a and the lower opening 14 formed in the lower surface curved portion 12a. That is, the portion of the air stream which causes generation of wingtip vortices is sucked by the first Francis turbine 8 and is discharged to the trailing edge side. Therefore, generation of the wingtip vortices can be suppressed.

In the present embodiment, the air sucked by the first Francis turbine 8 from the upper opening 13 and the lower opening 14 is discharged to a space close to the trailing edge of the main wing 3. Since the air discharged to the space close to the trailing edge of the main wing 3 becomes a vortex swirling in a direction opposite to the swirling direction of the wingtip vortices, the air discharged from the first Francis turbine 8 suppresses generation of the wingtip vortices at a space close to a trailing edge of a wing. Therefore, induced drag with respect to the aircraft 1 can be reduced. Accordingly, the fuel efficiency of the aircraft 1 can be improved.

In addition, in the present embodiment, the first Francis turbine 8 discharges air sucked from the upper opening 13 and the lower opening 14 toward the rear side, from the trailing edge side of the main wing 3. Accordingly, with the first Francis turbine 8, the air sucked from the pressure surface and the suction surface can be used as thrust of the aircraft 1.

In the present embodiment, generation of wingtip vortices is suppressed by means of the first Francis turbine 8 of which the central axis extends in a direction from a leading edge to the trailing edge of the wing, that sucks air from the circumferential direction, and that discharges the sucked air in the axial direction. Accordingly, it is possible to discharge air from the trailing edge side of the main wing 3 without providing a structure (for example, duct) for guiding air discharged from the first Francis turbine 8 to the trailing edge side. Therefore, the configuration of the fluid adjustment device 4 can be simplified.

### Modification Example 1

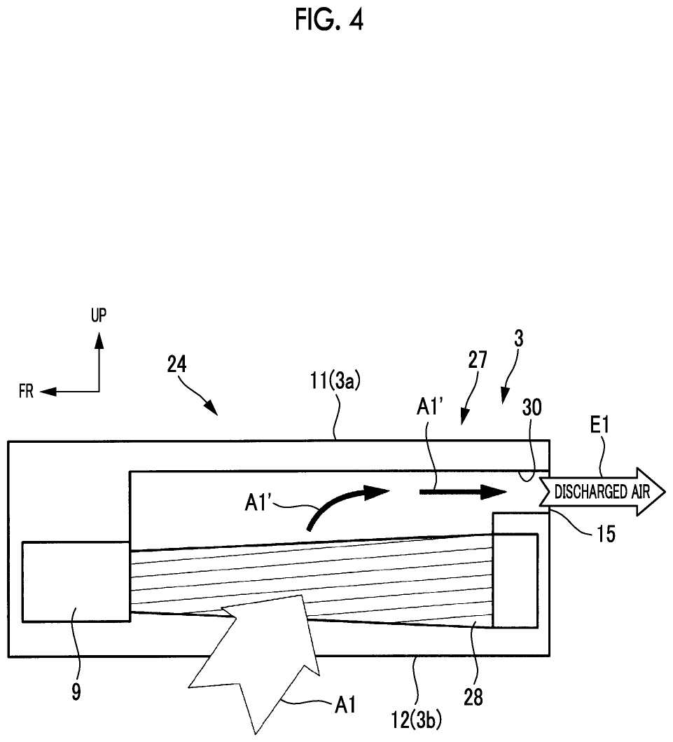

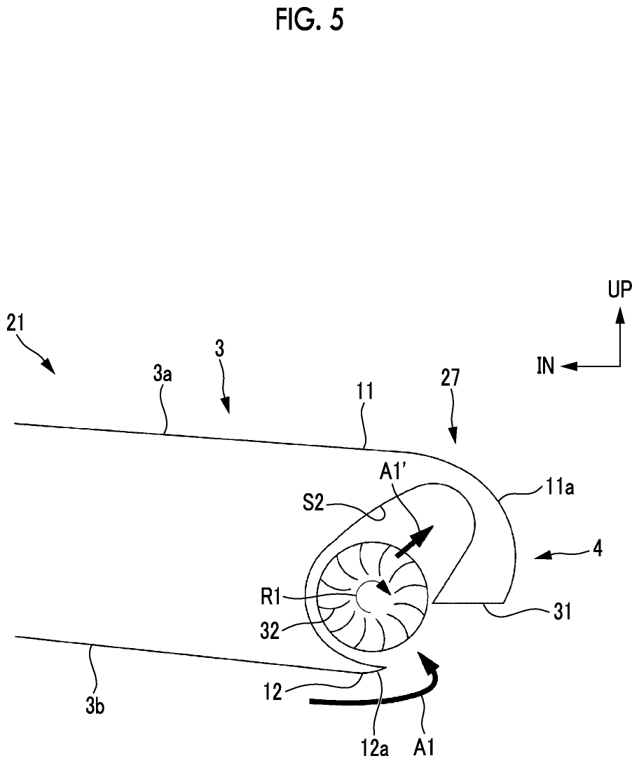

Next, a modification example (Modification Example 1) of the present embodiment will be described with reference to FIGS. 4 and 5. The fluid adjustment device 4 according to the present modification example is different from that in the first embodiment mainly in that a cross flow fan 28 is used instead of the first Francis turbine 8 as shown in FIGS. 4 and 5. The same components as those in the first embodiment will be given the same reference numerals and detailed description thereof will be omitted.

A fluid adjustment device 24 includes a body part 27 that is integrally formed with the main wing 3 and serves as a portion of the main wing 3, the cross flow fan 28 that is provided to be embedded in the body part 27, a duct 30 that guides air discharged from the cross flow fan 28 to the discharge opening 15, and the first motor 9 that is provided in front of the cross flow fan 28. The cross flow fan 28 is a fan that extends along the central axis and has a cylindrical shape. The cross flow fan 28 includes a plurality of blades extending to be approximately parallel with the central axis at a portion corresponding to an outer peripheral surface of the cylindrical shape and rotates around the central axis such that the plurality of blades transport air in a predetermined direction (upward in present embodiment).

In the case of the body part 27 according to the present modification example, the lower opening 14 through which a first internal space S2 and the outside communicate with each other is formed in the lower surface curved portion 12a while no upper opening 13 is formed in the upper surface curved portion 11a. In addition, as will be described later, the cross flow fan 28 and the duct 30 are accommodated in the first internal space S2 formed inside the body part 27. Therefore, the first internal space S2 is formed such that a section in a longitudinal direction has an oval shape.

The cross flow fan 28 is a cylindrical member that is rotatably disposed in the first internal space S2 such that the central axis thereof extends along the longitudinal direction of the first internal space S2. In addition, the cross flow fan 28 is formed such that the diameter thereof gradually increases toward the rear side from the front side. The cross flow fan 28 includes a plurality of blade portions 32 that are disposed to be arranged in the circumferential direction around the central axis at predetermined intervals. Since each blade portion 32 is provided apart from the central axis, a space that extends in the longitudinal direction while being centered on the central axis is formed inside the cross flow fan 28. Each blade portion 32 is formed such that air introduced from the circumferential direction flows in a tangential direction. That is, the cross flow fan 28 rotates around the central axis so that air is sucked from the circumferential direction (lower side in present embodiment) and the sucked air is discharged to the circumferential direction (upper side in present embodiment) opposite to a suction direction.

The duct 30 extends linearly in the front-rear direction and connects a rear end of an upper portion of the first internal space S2 and the discharge opening 15 to each other.

The first motor 9 is provided in front of the cross flow fan 28. The first motor 9 is electrically connected to the battery 6 provided in the fuselage 2 by means of the wire 17 and is driven by electric power from the battery 6. The first motor 9 is connected to a front end of the cross flow fan 28 and when the first motor 9 is driven, the cross flow fan 28 rotates around the central axis. Since the rotation direction of the cross flow fan 28 is the same as that of the first Francis turbine 8 in the first embodiment, detailed description thereof will be omitted.

Next, the effect of an aircraft 21 according to the present modification example will be described.

In the case of the aircraft 21 according to the present modification example, the first motor 9 is driven during navigation so that the cross flow fan 28 is rotationally driven. When the cross flow fan 28 rotates, as represented by arrows A1 in FIGS. 4 and 5, the cross flow fan 28 sucks a portion of an air stream flowing from the main wing lower surface 3b (pressure surface) to the main wing upper surface 3a (suction surface) via the lower opening 14 formed in the body part 27. The cross flow fan 28 discharges the sucked air upward and rearward. The air discharged from the cross flow fan 28 flows into the duct 30 as represented by arrows A1′. As represented by the arrow E1 in FIG. 4, the air flowing into the duct 30 is discharged to a space (rear space) close to the trailing edge of the main wing 3 via the discharge opening 15 formed in the body part 27. Since the cross flow fan 28 rotates in a direction opposite to a swirling direction of the wingtip vortices, the air discharged to the space close to the trailing edge of the main wing 3 becomes a vortex swirling in the direction opposite to the swirling direction of the wingtip vortices.

According to the present modification example, the following effects can be achieved.

In the present modification example, air is discharged by the cross flow fan 28 from the trailing edge side of the main wing 3. Since the configuration of the cross flow fan 28 is relatively simple, the cross flow fan 28 is small in comparison with a device having other functions (for example, a device that discharges air sucked from circumferential direction in axial direction), as a device sucking air from the circumferential direction. Therefore, the fluid adjustment device 24 can be made small.

In addition, since the blades of the cross flow fan 28 are provided to be approximately parallel with the central axis, the amount of suction in the longitudinal direction is made uniform in comparison with a configuration in which the blades are inclined with respect to the central axis. Accordingly, the amount of suction can be increased as a whole. Therefore, it is possible to suck a larger amount of air stream that causes generation of wingtip vortices and thus it is possible to further suppress generation of wingtip vortices.

### Second Embodiment

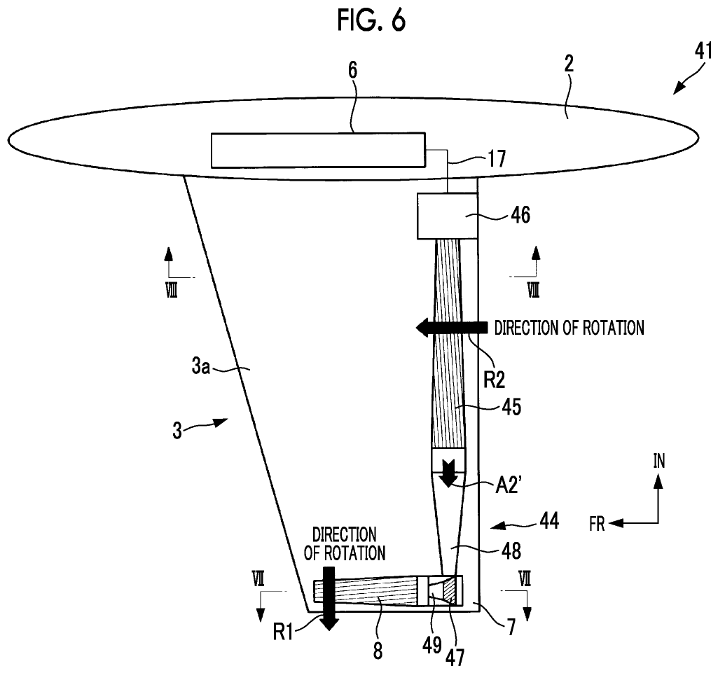

Next, a second embodiment of the present invention will be described with reference to FIGS. 6 to 8. A fluid adjustment device 44 according to the present embodiment is different from that in the first embodiment mainly in that a second Francis turbine 45 is provided and that a drive Francis turbine 47 is provided instead of the first motor 9. In the following description, the same components as those in the first embodiment will be given the same reference numerals and detailed description thereof will be omitted.

The fluid adjustment device 4 further includes the second Francis turbine (second fan) 45 that extends in the wing spanwise direction of the main wing 3 and is provided along the trailing edge of the main wing 3, a second motor (second drive unit) 46 that rotationally drives the second Francis turbine 45, the drive Francis turbine (turbine) 47 that rotationally drives the first Francis turbine 8, and an air duct 48 that guides air discharged from the second Francis turbine 45 to the drive Francis turbine 47. In addition, a second internal space S3 that extends in the wing spanwise direction (right-left direction) and of which a section in a longitudinal direction is approximately circular is formed in a rear end portion of the main wing 3 of the aircraft 1 according to the present embodiment. In addition, an upper surface opening 43 through which the internal space and the outside communicate with each other is formed in the main wing upper surface 3a. The length of the upper surface opening 43 in the wing spanwise direction is approximately the same as the length of the second internal space S3 in the wing spanwise direction.

The second Francis turbine 45 is rotatably disposed in the second internal space S3 such that the central axis thereof extends along the longitudinal direction of the second internal space S3. In addition, the second Francis turbine 45 rotates around the central axis so that air is sucked thereinto from the circumferential direction and the air sucked is discharged in the axial direction. The second Francis turbine 45 in the present embodiment discharges the sucked air in a wing tip direction. The other structure of the second Francis turbine 45 is approximately the same as that of the first Francis turbine 8 and thus detailed description thereof will be omitted.

The air duct 48 is a duct-shaped member. Through the air duct 48, an end portion of the second internal space S3 in the wing tip direction and an end portion of the first internal space S1 in a wing root direction communicate with each other. The air duct 48 extends linearly in a direction approximately the same as the central axis of the second Francis turbine 45. In addition, the air duct 48 extends to be orthogonal to the central axes of the first Francis turbine 8 and the drive Francis turbine 47.

The second motor 46 is provided at a wing root side end portion of the second Francis turbine 45. The second motor 46 is electrically connected to the battery 6 provided in the fuselage 2 by means of the wire 17 and is driven by electric power from the battery 6. The motor is connected to the wing root side end portion of the second Francis turbine 45 and when the second motor 46 is driven, the second Francis turbine 45 rotates around the central axis. Specifically, as represented by an arrow R2 in FIG. 6, the second Francis turbine 45 is rotated such that blade portions 50 move from a trailing edge side to a leading edge side of the main wing 3 at the upper half of the second Francis turbine 45 as seen in a plan view of the second Francis turbine 45. Note that, the rotation direction of the second Francis turbine 45 is not limited thereto and the second Francis turbine 45 may rotate in a direction opposite to the rotation direction described above.

The drive Francis turbine 47 is rotatably disposed in the first internal space S1 such that the central axis thereof extends along the longitudinal direction of the first internal space S1. In addition, the drive Francis turbine 47 rotates around the central axis so that air is sucked thereinto from the circumferential direction and the air sucked is discharged in the axial direction. The drive Francis turbine 47 in the present embodiment discharges the sucked air to the rear side in the axial direction. The other structure of the drive Francis turbine 47 is approximately the same as that of the first Francis turbine 8 and thus detailed description thereof will be omitted.

In addition, the drive Francis turbine 47 is provided behind the first Francis turbine 8. A front end of the drive Francis turbine 47 is connected to a rear end of the first Francis turbine 8 via a connecting member 49 and when the drive Francis turbine 47 rotates, the first Francis turbine 8 rotates also.

Next, the effect of an aircraft 41 according to the present embodiment will be described.

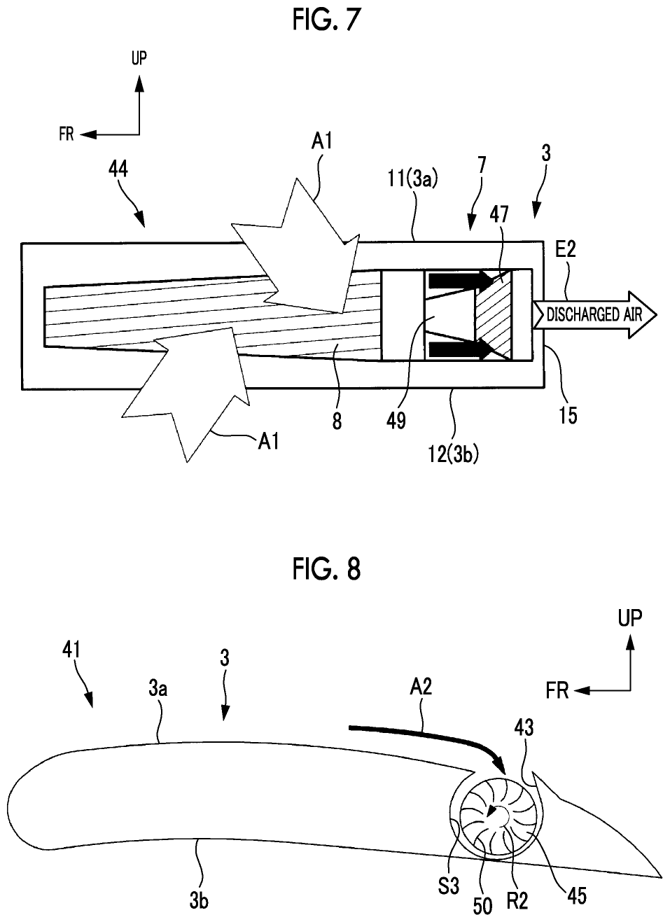

In the case of the aircraft 41 according to the present embodiment, the second motor 46 is driven during navigation so that the second Francis turbine 45 is rotationally driven. When the second Francis turbine 45 rotates, as represented by arrows A2 in FIG. 8, the second Francis turbine 45 sucks a portion of an air stream flowing in the vicinity of the main wing upper surface 3a (suction surface) via the upper surface opening 43 formed in the main wing 3. The second Francis turbine 45 discharges the sucked air in the axial direction. The air discharged from the second Francis turbine 45 is supplied to the drive Francis turbine 47 via the air duct 48 as represented by an arrow A2′ in FIG. 6. Specifically, the air is supplied from a circumferential direction of the drive Francis turbine 47. The drive Francis turbine 47 is rotationally driven by the supplied air. When the drive Francis turbine 47 is rotationally driven, the first Francis turbine 8 is also rotationally driven. As represented by an arrow E2 in FIG. 7, the air discharged from the drive Francis turbine 47 is discharged to a space (rear space) close to the trailing edge of the main wing 3 together with air discharged from the first Francis turbine 8 via the discharge opening 15 formed in the body part 7. Since the flow of air related to the first Francis turbine 8 is the same as that in the first embodiment, the description thereof will be omitted.

According to the present embodiment, the following effects can be achieved.

In the present embodiment, the second Francis turbine 45 is provided. Accordingly, separation of air can be suppressed with the second Francis turbine 45 sucking air separated from the main wing upper surface 3a. Therefore, induced drag with respect to the aircraft 41 can be suppressed. Accordingly, the fuel efficiency of the aircraft 41 can be improved.

In particular, since air flowing along the main wing upper surface 3a tends to separate when the aircraft 41 takes off or the like, the effect of the second Francis turbine 45 can be achieved in a more preferable manner.

In addition, air discharged from the second Francis turbine 45 is supplied to the drive Francis turbine 47 and the drive Francis turbine 47 drives the first Francis turbine 8. Since the drive Francis turbine 47 does not need a wire or the like, a configuration can be simplified and reduction in weight can be achieved in comparison with a configuration in which an electric motor or the like which needs a wire or the like is provided as a drive device for driving the first Francis turbine 8.

### Modification Example 2

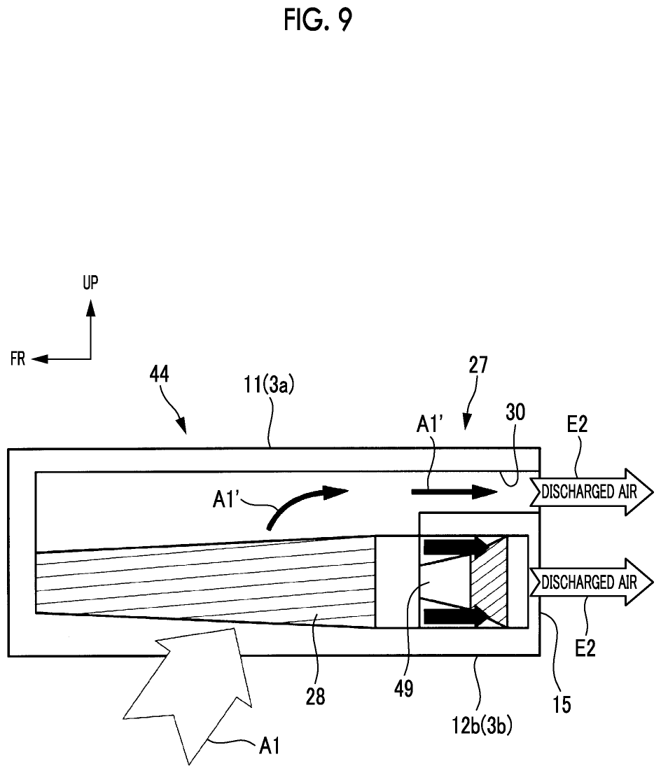

Next, a modification example (Modification Example 2) of the present embodiment will be described. The present modification example is different from the second embodiment in that the cross flow fan 28 is used as a blower provided at the wing tip of the main wing 3 instead of the first Francis turbine 8 as shown in FIG. 9. In the present modification example, similarly to the first Francis turbine 8 in the second embodiment, a rear end of the cross flow fan 28 is connected to the front end of the drive Francis turbine 47 via a connecting member. In addition, in the present modification example, similarly to Modification Example 1 of the first embodiment, the duct 30 that guides air discharged from the cross flow fan 28 to the discharge opening 15 is provided. With a configuration in the present modification example, the same effect as that of the second embodiment can be achieved.

### Modification Example 3

Next, another modification example (Modification Example 3) of the present embodiment will be described. The present modification example is different from the second embodiment in that a cross flow fan is used as a blower provided at the trailing edge of the main wing 3 instead of a second Francis turbine. In a configuration in the present modification example, a duct that guides air discharged from the cross flow fan to the drive Francis turbine 47 is provided. Note that, the structure of the cross flow fan used in the configuration is approximately the same as the structure of the cross flow fan 28 in the first embodiment. However, the cross flow fan applied to the configuration sucks air from an upper side and discharges (transports) the sucked air to a lower side.

With a configuration in the present modification example, the same effect as that of the second embodiment can be achieved.

In addition, as described above, since the blades of the cross flow fan are provided to be approximately parallel with the central axis, the amount of suction in the longitudinal direction is made uniform in comparison with a configuration in which the blades are inclined with respect to the central axis. Accordingly, the amount of suction can be increased as a whole. In the modification example, the cross flow fan is used as a turbine provided along the trailing edge of the main wing 3. Therefore, it is possible to suck a larger amount of air separated from the main wing upper surface 3a. Therefore, separation of air can be further suppressed.

Note that, the present invention is not limited to each of the above-described embodiments and can be appropriately modified without departing from the gist thereof.

For example, in the second embodiment, an example in which the second Francis turbine 45 sucks a portion of an air stream flowing in the vicinity of the main wing upper surface 3a via the upper surface opening 43 formed in the main wing upper surface 3a has been described. However, the present invention is not limited thereto. For example, an opening may be formed in the main wing lower surface 3b and a portion of the air stream flowing in the vicinity of the main wing lower surface 3b may be sucked via the opening. According to such a configuration, a boundary layer formed in the vicinity of the main wing lower surface 3b can be sucked and thus drag with respect to the aircraft 1 can be reduced. In addition, openings may be formed in both of the main wing upper surface 3a and the main wing lower surface 3b.

In addition, Modification Example 2 and Modification Example 3 of the second embodiment may be combined with each other. That is, the cross flow fan 28 may be used as a blower provided at the wing tip of the main wing 3 instead of the first Francis turbine 8 with a cross flow fan being used as a blower provided along the trailing edge of the main wing 3 instead of the second Francis turbine.

According to such a configuration, it is possible to further suppress generation of wingtip vortices by sucking a larger amount of air stream causing generation of wingtip vortices and it is possible to further suppress separation of air by sucking a large amount of air separated from the main wing upper surface 3a.

### REFERENCE SIGNS LIST

1: aircraft
2: fuselage
3: main wing
3a: main wing upper surface
3b: main wing lower surface
4: fluid adjustment device
6: battery
7: body part
8: first Francis turbine
9: first motor
11: body part upper surface
11a: upper surface curved portion
12: body part lower surface
12a: lower surface curved portion
13: upper opening
14: lower opening
15: discharge opening
16: blade portion
17: wire
28: cross flow fan
30: duct
32: blade portion
43: upper surface opening
45: second Francis turbine
46: second motor
47: drive Francis turbine
48: air duct
49: connecting member
50: blade portion
S1: first internal space
S2: first internal space
S3: second internal space

1. A fluid adjustment device comprising:
a body part that is provided at a wing tip, which is an end portion opposite to a wing root of a wing, and includes a suction opening formed in one or both of a pressure surface and a suction surface;
a first fan that sucks air from the suction opening and discharges the sucked air from a trailing edge side of the wing; and
a first drive unit that rotates the first fan in a direction opposite to a rotation direction of wingtip vortices generated at the wing tip.

2. The fluid adjustment device according to claim 1,
wherein the first fan is a Francis turbine of which a central axis extends in a direction from a leading edge to a trailing edge of the wing, that sucks air from a circumferential direction, and that discharges the sucked air in an axial direction.

3. The fluid adjustment device according to claim 1,
wherein the first fan includes
a cross flow fan of which a central axis extends in a direction from a leading edge to a trailing edge of the wing, that sucks air from a circumferential direction, and that discharges the air in the circumferential direction, and
a duct that guides the air discharged from the cross flow fan to the trailing edge side of the wing.

4. The fluid adjustment device according to claim 1, further comprising:
a second fan that extends in a wing spanwise direction of the wing, is provided along a trailing edge of the wing, sucks air along one or both of the pressure surface and the suction surface of the wing, and discharges the sucked air to a turbine; and
a second drive unit that rotationally drives the second fan,
wherein the first drive unit is the turbine that is provided at an end portion of the first fan in an axial direction and is rotationally driven by means of the air discharged from the second fan.

5. An aircraft comprising:
the fluid adjustment device according to claim 1.

6. The fluid adjustment device according to claim 2, further comprising:
a second fan that extends in a wing spanwise direction of the wing, is provided along a trailing edge of the wing, sucks air along one or both of the pressure surface and the suction surface of the wing, and discharges the sucked air to a turbine; and
a second drive unit that rotationally drives the second fan,
wherein the first drive unit is the turbine that is provided at an end portion of the first fan in an axial direction and is rotationally driven by means of the air discharged from the second fan.

7. The fluid adjustment device according to claim 3, further comprising:
a second fan that extends in a wing spanwise direction of the wing, is provided along a trailing edge of the wing, sucks air along one or both of the pressure surface and the suction surface of the wing, and discharges the sucked air to a turbine; and
a second drive unit that rotationally drives the second fan,
wherein the first drive unit is the turbine that is provided at an end portion of the first fan in an axial direction and is rotationally driven by means of the air discharged from the second fan.
